(19) United States
(12) Patent Application Publication
(10) Pub. No.: US 2013/0217511 A1
(43) Pub. Date: Aug. 22, 2013

(54) TORSIONAL VIBRATION DAMPER

(71) Applicants: Gregor Polifke, Giengen (DE); Rolf Brockmann, Heidenheim (DE); Miroslav Kovacevic, Heidenheim (DE); Philipp Müller, Buhlerzell (DE); Gunther Seitz, Heuchlingen (DE)

(72) Inventors: Gregor Polifke, Giengen (DE); Rolf Brockmann, Heidenheim (DE); Miroslav Kovacevic, Heidenheim (DE); Philipp Müller, Buhlerzell (DE); Gunther Seitz, Heuchlingen (DE)

(73) Assignee: VOITH PATENT GMBH, Heidenheim (DE)

(21) Appl. No.: 13/811,014

(22) PCT Filed: Jul. 9, 2011
(86) PCT No.: PCT/EP2011/003434

§ 371 Date: Feb. 27, 2013

(30) Foreign Application Priority Data
Jul. 27, 2010 (DE) 10 2010 032 400.0

(51) Int. Cl. F16D 3/12

(52) U.S. Cl. CPC F16D 3/12
USPC 464/101

(57) ABSTRACT

The invention relates a torsional vibration damper, comprising the following features: a primary part with two lateral discs (1, 2) which are connected to each other for conjoint rotation; a secondary part with a central disc (3) which is arranged between the lateral discs; a primary part and secondary part are rotationally connected to each other via springs (5); damping chambers which are filled with a damping medium and each have at least one throttle opening; guide elements (7.1) are provided for supporting and guiding the springs. The invention is characterized by the following features: each spring is assigned two guide elements which are both arranged at mutual axial distance and form the supporting surfaces against a movement of the spring in the radial and in the axial direction.

The invention relates to an apparatus for damping vibrations. Such apparatuses can be used in drive trains with and without a torque transmission function. The drive trains can comprise an internal combustion engine or an electric motor. Such apparatuses for damping vibrations are used especially as torsional vibration dampers for an internal combustion engine or as a dual mass flywheel (see the preamble of claim 1).

U.S. Pat. No. 5,573,460 shows and describes an elastic coupling in disk configuration, comprising two coupling halves which are twistable with respect to each other within limits and are connected with each other via elastic coupling elements. Damping chambers are disposed in the radially outer region of an internal space, which damping chambers can be filled with a damping medium.

Couplings of the kind mentioned above are provided for ensuring the running smoothness of drives with internal combustion engines, especially in vehicles, in all operating and speed ranges. In particular, disturbing torsional vibrations shall be kept away from the drive train.

The elasticity of the coupling is chosen in such a way that the critical speed of the system of masses consisting of engine and transmission lies sufficiently beneath the operating range. In this respect, the origination of excessive amplitudes and torsional moments in the drive elements shall be prevented when passing through the critical speed. A substantial contribution in this respect is made by a damping device in the coupling per se which is adjusted to the drive train, which is a hydraulic damping by displacing damping medium through a defined gap. The problem in this respect is that there is a different torsional vibration behavior depending on the type of engine (gasoline engine, diesel engine) or the number of cylinders or the cylinder arrangement (in-line engine, V-engine), or also the transmission.

DE 10 2005 046 334 A1 describes a torsional vibration tamper according to the preamble of claim 1. A wearing shell is provided which extends radially outside of each bow spring in its longitudinal direction and is used for guiding the bow spring.

A similar system is known from DE 10 2006 046 601 A1 (cf. the plastic part 16 there).

It is expected that a torsional vibration damper efficiently dampens the torsional vibrations generated by the engine. In particular, a “soft” spring characteristic is desirable in order to reduce the resonant frequency of the damper to the highest possible extent. Car manufacturers further demand low weight and low overall volume. In times of stiff competition the production costs are especially important. Optimization is urgently desired with respect to all of these requirements.

The invention is based on the object of providing a torsional vibration damper according to the preamble of claim 1 in such a way that it fulfils its damping function as well as known dampers or even better than such dampers, and that it has a simple configuration and is therefore more cost-effective in production. At the same time the weight can be lower than known dampers depending on the constructional configuration.

This object is achieved by a torsional vibration damper according to claim 1.

The core idea of the invention consists of a special guide and stop device which is associated with each spring. The guide and stop device respectively comprises two arc-shaped or straight guide elements for supporting and guiding arc-shaped or straight springs. It is very decisive that each spring is associated with two guide elements, one each on one side of the longitudinal axis of the respective spring. Each guide element covers a portion of the radially outside quadrant of the spring. It therefore forms a support and guide for the spring, not only against the movement in the radial direction but also in the axial direction. It is especially important that the two guide elements which are associated with a spring are provided with an axial distance from one another in their radially outermost regions. The middle disk can be guided through said distance. This penetration is advantageous because in this case the damping chambers can be arranged radially far to the outside and will provide a respectively large effect of the damping. The damping system can be a frictional damping element system, a hydraulic damping system or a combination of these two systems.

A guide element may comprise two stop cheeks which both cooperate with one and the same lateral disk. The spring rests in the unloaded state with its two spring ends FA and FB simultaneously on the stop cheeks A and B. During spring deflection, it will only rest with its one spring end FA on the stop cheek A, and with its other spring end FB only on the contact surface MB of the middle disk associated with the spring end FB. As an alternative to this, the spring end FB is in contact with the stop cheek B in the case of opposite spring deflection, whereas the spring end FA will rest on the stop surface MA of the middle disk associated with the spring end FA.

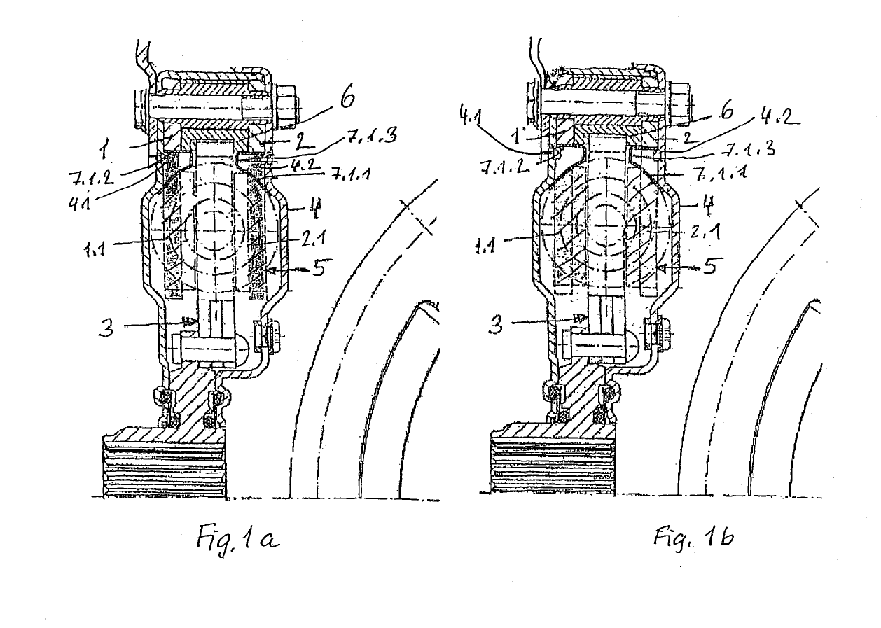

In the normal case, two guide elements will always cooperate on both sides of the bow spring, as shown in FIGS. 1a and 1b.

The guide element and the two stop cheeks can form a single component with each other. In this case, the three elements as mentioned above are not only joined together from three parts, but can be produced right from the start as a single component. In any case, the three parts should consist of low-wear material.

The guide and stop device fulfils the following functions:
radial and axial spring support;
radial and axial spring guidance;
support of centrifugal force;
spring guidance during spring deflection;
transmission of a force as a result of torque on the springs;
an increase of the support and contact surface, especially in the axial direction of the torsional vibration damper, in order to ensure sufficient power transmissions between the lateral disks and all springs of a spring assembly even when using several springs arranged in each other within the spring assembly.

The invention provides the following advantages:
fewer components;
reduction of processing work by integration of functions;
simple production of guides and stops;
reduction of wear and tear in springs and guide elements;
production of only few components (one or two) with high tolerance quality;
simple adaptation to different spring component placements;
realization of a larger contact surface between guide and stop device and spring, and lower wear and tear at this point by lower surface pressing as a result of the larger surface area;
transmission of a force also onto the inner springs when using several springs arranged within each other within a spring assembly.

The optionally arc-shaped guide element can be produced as an injection-molded part made of plastic. It can be provided with a massive configuration. It can be arranged as a deep-drawn sheet metal part. It can be introduced during mounting as follows, depending on the chosen embodiment:
by clipping;
by inserting;
by riveting;
by welding.

Any kind of metal or ceramic or plastic or composite material can be considered as the material for the guide and stop device. The relevant aspects are good sliding properties and favorable wearing properties.

The invention will be explained below in closer detail by reference to the drawings which show the following in detail:

FIG. 1a shows a torsional vibration damper in an axially vertical sectional view with the stop surfaces of the two lateral disks;

FIG. 1b shows a torsional vibration damper in an axially vertical sectional view with the stop surfaces of the two stop cheeks;

FIG. 2 shows the subject matter of FIG. 1a in a side view, therefore as seen in the axial direction, with parts being omitted for reasons of clarity of the illustration;

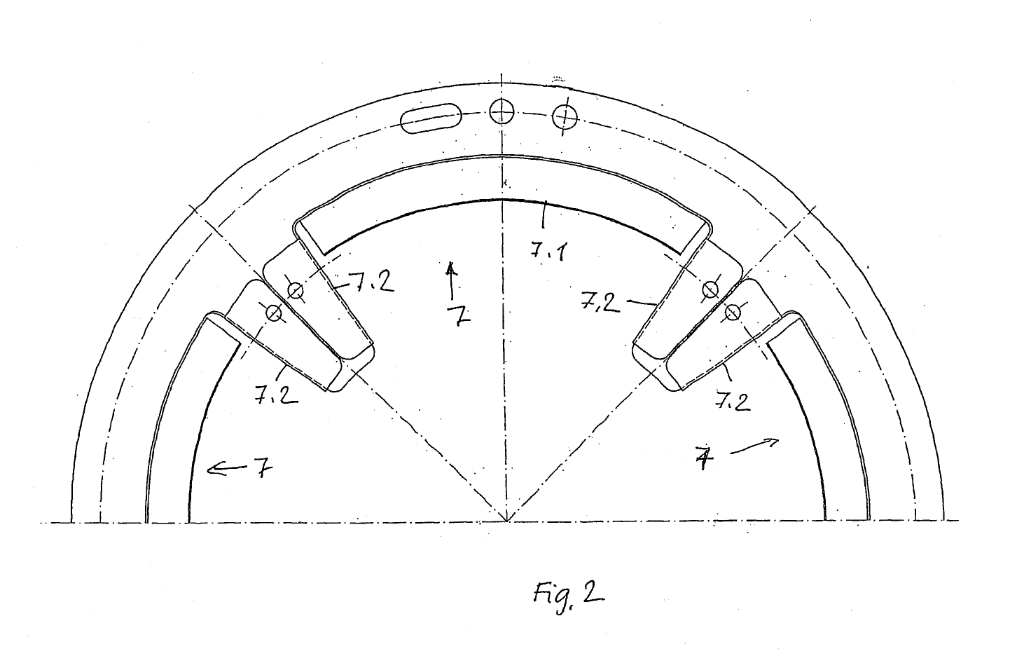

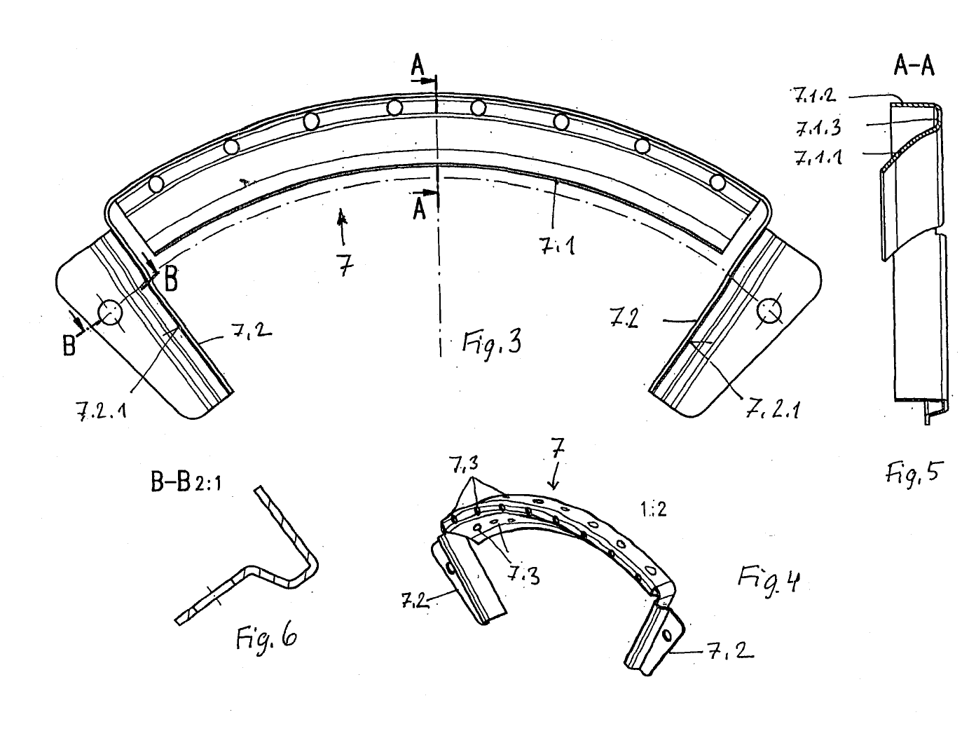

FIG. 3 shows a guide and stop device in a top view;

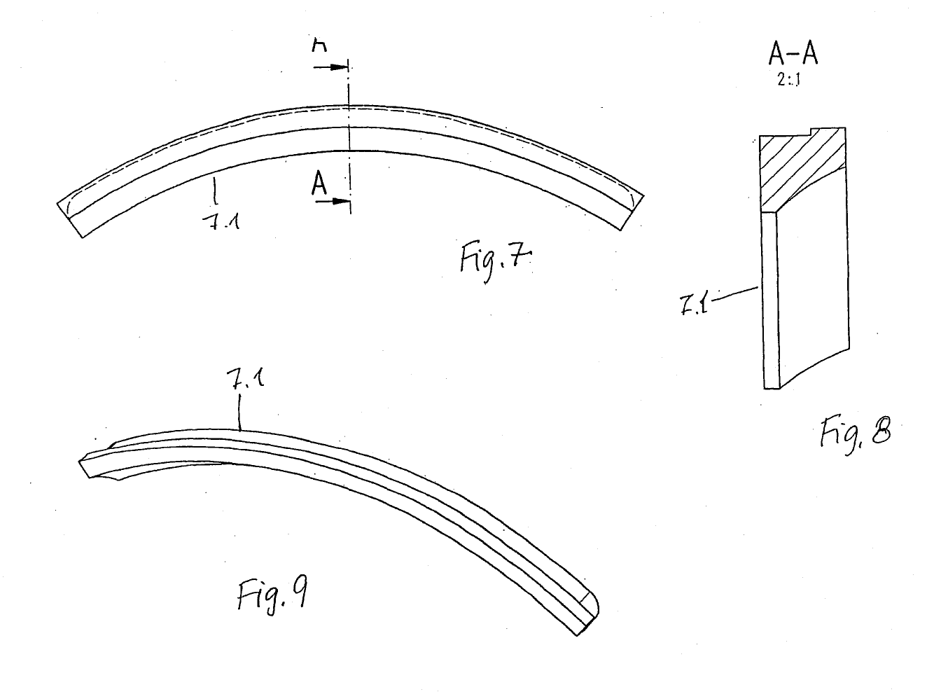

FIG. 4 shows the subject matter of FIG. 3 in a reduced perspective view;

FIG. 5 shows a sectional view according to the line of intersection A-A of FIG. 3;

FIG. 6 shows a view B-B of FIG. 3;

FIG. 7 shows the guide and stop device in a massive configuration;

FIG. 8 shows a sectional view according to the line of intersection A-A of FIG. 7;

FIG. 9 shows a perspective view of the subject matter of FIG. 7.

The torsional vibration damper as shown in FIGS. 1a and 1b respectively comprises a primary part with two lateral disks 1, 2 which are connected with each other in a torsion-proof manner. A secondary part is further provided, comprising a middle disk 3 which is arranged between the lateral disks 1, 2. A housing 4 encloses the primary part and the secondary part and is a component of the primary part itself.

A spring 5 can be recognized. It is arranged in an arc-shaped manner, but can also be arranged in a straight or cylindrical way. The spring 5 is disposed radially within the inner wall 6 of a damping chamber segment.

The decisive component is the guide and stop device 7 (also see FIGS. 2 to 4). The spring/springs can be arranged in a spring window segment. Each spring window segment for accommodating a spring assembly which respectively consists of at least one bow spring is associated with two guide and stop devices 7, one each axially on each side of the respective bow spring. Every guide device 7 is made of steel sheet by means of a deep-drawing process. It comprises a guide element 7.1. The latter comprises a substantially U-shaped profile with a first leg 7.1.1, a second leg 7.1.2 and a web 7.1.3. The leg 7.1.1 rests on the bow spring. The leg 7.1.2 extends in an axially parallel manner. It rests on the respective lateral disk 1 or 2, and further on the radially inner boundary surface of the damping chamber wall 6 on the damping segment. It is understood that it is possible to use any other suitable sheet material instead of steel sheet such as aluminum sheet. The guide elements are not limited to the advantageous use for bow springs, but can also be used for straight or cylindrical springs instead of bow springs.

The guide element 7.1 is simultaneously used for radially inner support and guidance of the damping chamber segment.

The important aspect is that the two guide elements 7.1 are provided with such a mutual axial distance that the middle disk 3 is able to engage between said guide elements. As a result, the damping chamber segments can be disposed on a large radius and can therefore also develop a respectively high effect.

The housing 4 comprises two stops 4.1 and 4.2. They are used for supporting the radially outer leg 7.1.2 of the guide element 7.1 against the radially inwardly acting pressure as exerted by the damping chamber.

FIG. 2 shows a complete guide and stop device 7 with the guide element 7.1 and two cheeks 7.2 and 7.2. The two cheeks 7.2, 7.2 are used for cooperation with respective contact surfaces of the lateral disks 1 and 2. FIG. 1a shows the contact surfaces of the lateral disk 1 with a hatched illustration. FIG. 1b shows of the contact surfaces of the two stop cheeks with a hatched illustration.

FIGS. 3 to 6 show the details of the guide and stop device 7. The arc-shaped guide element 7.1 is made of a steel sheet. FIG. 5 shows this in closer detail, especially the two legs 7.1.1 and 7.1.2 of the U-profile and the interposed web 7.1.3. The two cheeks 7.2 and 7.2 are also made of a steel sheet, which is integral with the arc-shaped guide element 7.1.

FIG. 3 shows the stop surfaces of the two cheeks 7.2, 7.2 in closer detail, which cooperates with the respective lateral disk 1 and 2.

FIGS. 3 and 4 show a plurality of openings 7.3. They have the following meaning:

As is shown in FIGS. 1a and 1b, a dead space is disposed in the region axially between the walls of the housing 4 and the side of the guide elements 7.1 facing away from the spring 5. Said dead space can be filled during operation with damping medium or lubricating grease, e.g. in such a way that the medium enters the dead space during operation by centrifugal force or as a result of gravity during the standstill. Since the dead space is substantially separated from the remaining inner space of the housing 4 as a result of the shape of the sheet metal of the guide element 7.1, damping medium or lubricating grease disposed in the dead space can no longer be returned (or only with difficulty) to the working store of the damping medium or lubricating grease.

A plurality of passage openings 7.3 remedies this problem. The passage openings allow the medium to flow back from the dead space into the remaining inner space of the housing 4. The returned medium will then be used for operation again. Improved hydraulic damping or more even hydraulic damping as a result of optimized damping medium filling will be achieved. Furthermore, the passage openings 7.3 can further be optimized and be configured in a purposeful manner, so that the lubricant is guided in a purposeful manner to important zones in contact between components moved relative to one another, e.g. between spring 5 and guide device 7, so that wear and tear is reduced or eliminated.

The passage openings 7.3 allow a flow in the axial direction in the illustrated embodiment. The passage openings 7.3 can also be arranged in such a way that a flow will extend in the radial direction associated inwardly to the spring guide surface, or externally in the direction of the damping chamber (see FIG. 4).

In the case of the arrangement of the guide and stop device 7 as a deep-drawn component, the passage openings 7.3 can be introduced into the leg 7.1.1 and/or the leg 7.1.2 and/or the web 7.1.3 of the guide elements 7.1.

The aforementioned passage openings 7.3 can also be made of injection-molded parts or components made from a solid piece of material (not shown).

The arc-shaped guide elements 7.1 as shown in FIGS. 7 to 9 is provided with a massive configuration. It can consist of any material, e.g. plastic, metal, ceramics or a composite material. It is understood that the guide elements 7.1 are arranged in pairs again, as in the embodiments according to FIGS. 1a and 1b.

The stop cheeks need not be provided integrally with the guide elements. The guide elements 7.1 can also be arranged without stop cheeks. In this case, the stop surfaces of the lateral disks and/or the middle disk are hardened or provided with a “hard” cap.

The guide element 7.1 is simultaneously generally used for the inner support and guidance of a segment of a damping chamber. This is shown in FIGS. 1a and 1b. In this case, the axial parallel leg 7.1.2 rests on the damping chamber wall 6.

### LIST OF REFERENCE NUMERALS

1 Lateral disk
1.1 Stop surface
2 Lateral disk
2.1 Stop surface
3 Middle disk
4 Housing
5 Spring
6 Damping chamber wall
7 Guide and stop device
7.1 Arc-shaped guide element
7.1.1 Leg of the U-profile
7.1.2 Leg of the U-profile
7.1.3 Web
7.2 Cheek
7.3 Passage opening

1. A torsional vibration damper, comprising the following features:
a primary part with two lateral disks (1) and (2) which are connected with each other in a torsion-proof manner;
a secondary part with a middle disk (3) which is arranged between the lateral disks (1) and (2);
the primary part and the secondary part are in rotational connection with each other via springs (5);
damping chambers which are filled with a damping medium and respectively comprise at least one throttling opening;
guide elements (7.1) are provided for supporting and guiding the springs (5);
two guide elements (7.1) are associated with each spring (5), said guide elements being arranged at a mutual axial distance from each other and forming the support surfaces against a movement of the spring (5) in the radial and also axial direction characterized by the following features:
the guide elements (7.1) are connected with the lateral disks (1) and (2) in an entrainment-proof manner.

2. A torsional vibration damper according to claim 1, characterized in that the springs (5) are bow springs.

3. A torsional vibration damper according to claim 1, characterized by the following features:
each guide element (7.1) comprises at each end a stop cheek (7.2) for supporting the spring (5) or a spring assembly with inner springs arranged within an outer spring on the lateral disks (1, 2) during twisting between primary and secondary part.

4. A torsional vibration damper according to claim 3, characterized in that the guide element (7.1) and the stop cheeks (7.2) and (7.2) are integral.

5. A torsional vibration damper according to claim 4, characterized in that the guide element (7.1) and the stop cheeks (7.2) and (7.2) are produced in one single operation.

6. A torsional vibration damper according to claim 3, characterized in that at least one of the elements of guide element (7.1) and stop cheeks (7.2) and (7.2) consists of steel sheet.

7. A torsional vibration damper according to claim 2, characterized in that at least one of the elements of guide element (7.1) and stop cheeks (7.2) and (7.2) is massive.

8. A torsional vibration damper according to claim 1, characterized in that the lateral disks (1) and (2) comprise stop surfaces (1.1, 2.1) which cooperate with the stop cheeks (7.2) and (7.2).

9. A torsional vibration damper according to claim 1, characterized in that separate components are provided as stop cheeks, which are arranged either massively or as an injection-molded part or as a deep-drawn component.

10. A torsional vibration damper according to claim 1, characterized in that the lateral disks (1, 2) are provided with areas which are used as stop cheeks.

11. A torsional vibration damper according to claim 1, characterized in that the stop cheeks are respectively arranged as a separate component which is especially massive, or as an injection-molded part or as a deep-drawn component.

12. A torsional vibration damper according to claim 1, characterized in that the guide elements (7.1) are used for radially inner support and/or sealing of a damping chamber.

13. A torsional vibration damper according to claim 1, characterized in that the two guide elements (7.1, 7.1), as seen in an axial sectional view through the rotational axis of the torsional vibration damper, have such a mutual axial distance from each other that the middle disk (3) can be guided radially to the outside between the two guide elements (7.1, 7.1).

14. A torsional vibration damper according to claim 1, characterized in that the damping chambers are arranged in a segment-like manner over the external circumference of the torsional vibration damper, and the springs (5) are positioned radially within the damping chambers, especially radially within the radially inner boundary surface of the damping chamber wall (6).

15. A torsional vibration damper according to claim 1, characterized in that a housing (4) is provided which encloses the primary part and the secondary part at least in part, with the housing (4), the primary part and the secondary part forming a modular unit.

16. A torsional vibration damper according to claim 1, characterized in that the guide element (7.1) comprises a plurality of passage openings (7.3) for guiding through damping medium or lubricating grease, said openings being especially arranged as through-holes.

17. A torsional vibration damper according to claim 6, characterized in that the lateral disks are provided with areas which are used as stop cheeks.

18. A torsional vibration damper according to claim 6, characterized in that the stop cheeks are respectively arranged as a separate component which is especially massive, or as an injection-molded part or as a deep-drawn component.
